(19) United States
(12) Patent Application Publication
(10) Pub. No.: US 2026/0237975 A1
(43) Pub. Date: Aug. 13, 2026

(54) ELECTRON BEAM IONIZATION BASED IONIC WIND DEVICE

(71) Applicant: Peking University, Beijing (CN)

(72) Inventors: Xianlong WEI, Beijing (CN); Shuyu MAO, Beijing (CN)

(73) Assignee: Peking University, Beijing (CN)

(21) Appl. No.: 19/154,786

(22) PCT Filed: Jan. 29, 2024
(86) PCT No.: PCT/CN2024/074368

§ 371 Date: Aug. 7, 2025

(30) Foreign Application Priority Data
Feb. 10, 2023 (CN) 202310096646.3

(51) Int. Cl. H01T 23/00

(52) U.S. Cl. CPC H01T 23/00

(57) ABSTRACT

An electron beam ionization based ionic wind device includes a vacuum chamber, an electron source, an electron beam accelerating electrode, an electron beam exit window, and an ion accelerating electrode. The electron source is positioned inside the vacuum chamber and used to generate an electron beam. The electron beam accelerating electrode is positioned inside the vacuum chamber, on a chamber wall of the vacuum chamber, or outside the vacuum chamber, and used to accelerate the electron beam. The electron beam exit window is positioned on the chamber wall of the vacuum chamber. The electron beam is emitted to the outside of the vacuum chamber through the electron beam exit window and ionizes gas molecules or is attached to gas molecules outside the vacuum chamber to form ions. The ion accelerating electrode is positioned outside the vacuum chamber and used to accelerate the ions to generate ionic wind.

### CROSS-REFERENCE TO RELATED APPLICATIONS

This application is a National Stage of International Application No. PCT/CN2024/074368, filed on Jan. 29, 2024, which claims priority to CN patent application No. 202310096646.3 filed on Feb. 10, 2023, both of which are incorporated herein by reference in their entireties.

### TECHNICAL FIELD

Embodiments of the disclosure generally relate to the field of electrical, and in particular, to an electron beam ionization based ionic wind device.

### BACKGROUND

Ionic wind is generated by ionizing air to generate ions, accelerating the ions by an electric field to make the ions collide with air molecules during drifting and transfer momentum to them, thereby driving overall flow of air. Compared with wind generated by mechanical fans, the ionic wind has advantages of low noise, low power consumption, no mechanical moving parts, and fast response speed, and it may be widely used in fields such as heat dissipation of chip, aerobat propulsion, and food drying.

### SUMMARY

An electron beam ionization based ionic wind device according to embodiments of the disclosure, at least including a vacuum chamber, an electron source, an electron beam accelerating electrode, an electron beam exit window, and an ion accelerating electrode, wherein: the electron source is positioned inside the vacuum chamber and is used to generate an electron beam; the electron beam accelerating electrode is positioned inside the vacuum chamber, or on a chamber wall of the vacuum chamber, or outside the vacuum chamber, and is used to accelerate the electron beam; the electron beam exit window is positioned on the chamber wall of the vacuum chamber, through which the electron beam is emitted to outside of the vacuum chamber and ionizes or adsorbs gas molecules outside the vacuum chamber to form ions; and the ion accelerating electrode is positioned outside the vacuum chamber and is used to accelerate the ions to generate ionic wind.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 shows a structure diagram of an electron beam ionization based ionic wind device according to some embodiments of the disclosure.

FIG. 2 shows a structure diagram of an electron beam ionization based ionic wind device according to some other embodiments of the disclosure.

FIGS. 3 and 4 show diagrams of a fitting mode between an electron beam accelerating electrode and an electron beam exit window shown in FIG. 2.

FIG. 5 shows a structure diagram of an electron beam ionization based ionic wind device according to some other embodiments of the disclosure.

FIG. 6 shows a structure diagram of an electron beam ionization based ionic wind device according to some other embodiments of the disclosure.

FIG. 7 shows a structure diagram of an electron beam ionization based ionic wind device according to some other embodiments of the disclosure.

FIG. 8 shows a structure diagram of an electron beam ionization based ionic wind device according to some other embodiments of the disclosure.

FIG. 9 shows a structure diagram of an electron beam ionization based ionic wind device according to some other embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment”, “in one embodiment”, and “in some embodiments” are used repeatedly herein. The phrases generally do not refer to the same embodiment; however, they may. The terms “comprising”, “having”, and “including” are synonymous, unless the context dictates otherwise. The phrases “A or B” and “A/B” mean “(A), (B), or (A and B).”

Currently, ionic wind devices generate ionic wind mainly based on two principles: corona discharge and dielectric barrier discharge. According to the principle of corona discharge, a highly asymmetric electric field may be generated by applying voltage between a pair of electrodes with significantly different curvature radii. High electric field strength on surfaces of the electrodes with high curvature ionizes air and thus the ionic wind is generated. Due to the weakened electric field strength at a certain distance from the electrodes with high curvature, air ionization is stably confined to vicinity of the electrodes with high curvature by this setting of the electrodes, which greatly reduces efficiency of air ionization and available ion concentration. Dielectric barrier discharge also requires two electrodes. Unlike corona discharge, a surface of one or both of the electrodes is covered with an insulating medium. By applying alternating voltage between the two electrodes, the air between them may be ionized and thus the ionic wind may be generated. Presence of the insulating medium may stabilize the discharge and prevent sparks from occurring. Performance of the ionic wind devices based on dielectric barrier discharge is inferior to that of the ionic wind devices based on corona discharge.

Although the ionic wind devices based on corona discharge have met requirements of practical applications in terms of thrust-to-power ratio (a ratio of generated thrust to consumed power) and thrust density (thrust generated per unit area) separately, they are not put into practical applications yet. One important reason is that they cannot simultaneously achieve an ideal thrust-to-power ratio and thrust density. Specifically, in the ionic wind devices based on corona discharge, both a process of generating ions and a process of accelerating the ions to generate the ionic wind are implemented and decided by discharge voltage. Due to negative correlation between the thrust-to-power ratio and the discharge voltage, and positive correlation between the thrust density and the discharge voltage, the ideal thrust-to-power ratio and thrust density cannot be achieved simultaneously. Meanwhile, as the process of generating the ions and the process of accelerating the ions to generate the ionic wind are coupled together, sufficient ions cannot be generated and sufficiently accelerated, resulting in limited ionic wind speed and energy efficiency. In addition, the threshold voltage of gas discharge is high and discharge stability is low in an atmospheric environment, resulting in high operating voltage and low operating stability of the ionic wind devices. In order to realize better practical applications, it is necessary to meet requirements of the practical applications in terms of both the thrust-to-power ratio and the thrust density simultaneously, and further reduce the operating voltage of the ionic wind devices, or further improve their wind speed and energy efficiency at certain operating voltage.

In view of the above situation, an electron beam ionization based ionic wind device according to embodiments of the disclosure is proposed, in which the ions are generated by ionizing gas molecules with an electron beam or attaching electrons to gas molecules, and the ionic wind is generated by accelerating the ions with an electric field. The generating of the ions is implemented and decided by the electron beam, and the accelerating of the ions to generate the ionic wind is implemented and decided by ion accelerating voltage. Hence, by controlling the electron beam and the ion accelerating voltage separately, the ideal thrust-to-power ratio and thrust density can be achieved simultaneously. At the same time, ionization efficiency of the gas molecules and strength of the electric field for ion acceleration can be improved, and higher wind speed and energy efficiency can be obtained without increasing the operating voltage.

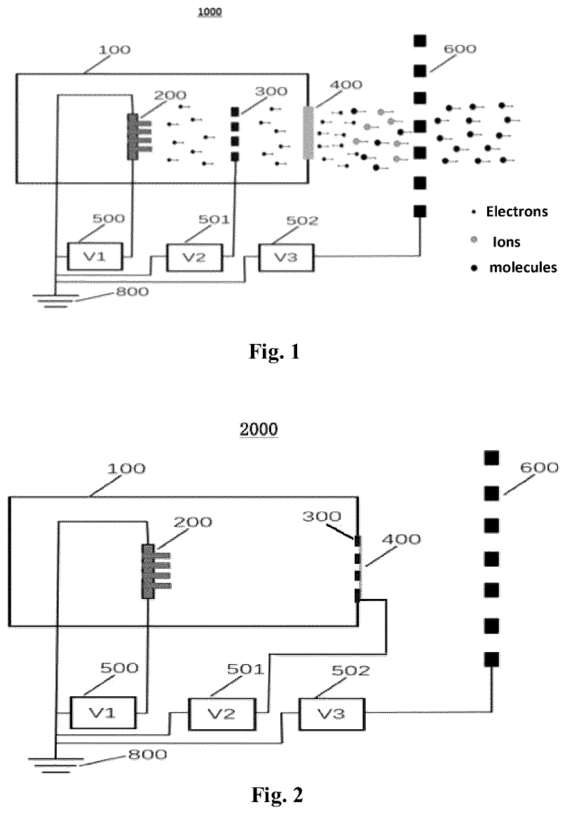

FIG. 1 shows a structure diagram of an electron beam ionization based ionic wind device according to some embodiments of the disclosure. As shown in FIG. 1, in some embodiments, the electron beam ionization based ionic wind device 1000 includes a vacuum chamber 100, an electron source 200, an electron beam accelerating electrode 300, an electron beam exit window 400, an electron source power supply 500, an electron beam accelerating electrode power supply 501, an ion accelerating electrode power supply 502, an ion accelerating electrode 600, and a grounding point 800. The electron source 200 and the electron beam accelerating electrode 300 are positioned inside the vacuum chamber 100, and the electron beam exit window 400 is positioned on a chamber wall of the vacuum chamber 100. The electron beam exit window 400 maintains an air pressure difference between the vacuum chamber 100 and an external gas environment, and allows the electron beam to pass through it and be emitted to the outside of the vacuum chamber 100. The electron source power supply 500 supplies power for the electron source 200, causing the electron source 200 to generate the electron beam. The electron beam accelerating electrode power supply 501 supplies power for the electron beam accelerating electrode 300, causing the electron beam accelerating electrode 300 to provide an electron beam accelerating electric field. The ion accelerating electrode power supply 502 supplies power for the ion accelerating electrode 600, generating an ion accelerating electric field between the electron beam accelerating electrode 300 or the electron beam exit window 400 and the ion accelerating electrode 600. The ion accelerating electric field may be a positive electric field to accelerate negative ions, or a negative electric field to accelerate positive ions.

As shown in FIG. 1, in some embodiments, the electron beam exit window 400, the electron source 200 and the electron beam accelerating electrode 300 are aligned in a straight line, and the ion accelerating electrode 600 is positioned in front of the electron beam exit window 400. In this case, the direction of the electron beam incident on the atmospheric air or other gases is parallel to the direction of the ion accelerating electric field. It should be understood that the electron beam exit window 400 may also not be on the same straight line as at least one of the electron source 200 and the electron beam accelerating electrode 300. A traveling path of the electron beam inside the vacuum chamber 100 may be adjusted by reflecting it once or multiple times, as long as the electron beam may be emitted to the outside of the vacuum chamber 100 through the electron beam exit window 400 after being accelerated by the electron beam accelerating electrode 300.

In some embodiments, the electron beam accelerating electrode 300 may also be positioned on the chamber wall or outside of the vacuum chamber 100, as long as it can accelerate the electron beam during the process of the electron beam being emitted to the outside of the vacuum chamber 100 through the electron beam exit window 400. In addition, the ion accelerating electrode 600 may also not be positioned in front of the electron beam exit window 400 (e.g., behind, on the side, etc.), in which case the ion accelerating electric field may also be generated between the electron beam accelerating electrode 300 or the electron beam exit window 400 and the ion accelerating electrode 600.

In some embodiments, the electron source 100 may include one or more of a thermionic emission electron source, a field emission electron source, and a tunneling electron source, and/or may include a focusing device, a function of which is to make the electron beam more concentrated towards the electron beam exit window 400, so that more electron beams are emitted to the outside of the vacuum chamber 100 through the electron beam exit window 400. The electron beam accelerating electrode 300 and the ion accelerating electrode 600 may be grid electrodes or electrodes of other shapes.

As shown in FIG. 1, in some embodiments, the electron beam exit window 400 has a thin-film or micropore structure. The electron beam is emitted to the outside of the vacuum chamber 100 through the electron beam exit window 400, ionizing the gas molecules outside the vacuum chamber 100 to form positive ions or being attached to the gas molecules outside the vacuum chamber 100 to form negative ions.

When the electron beam ionization based ionic wind device 1000 shown in FIG. 1 is in operation, the electron source 200 generates the electron beam. The electron beam is accelerated by the electron beam accelerating electrode 300 and then is emitted to the outside of the vacuum chamber 100 through the electron beam exit window 400, entering the external atmospheric air or other gas environments. In the atmospheric air or other gas environments, the electron beam collides with the gas molecules, ionizing the gas molecules to form the positive ions or being attached to the gas molecules to form the negative ions. The positive and/or negative ions are accelerated by the ion accelerating electric field, colliding with the gas molecules and transferring momentum to the gas molecules and thus driving them to generate macroscopic airflow.

In the electron beam ionization based ionic wind device according to embodiments of the disclosure, the generating of the ions is implemented and decided by the electron beam, and the accelerating of the ions to generate the ionic wind is implemented and decided by the ion accelerating voltage. Hence, the ideal thrust-to-power ratio and thrust density may be simultaneously achieved by controlling the electron beam and ion accelerating voltage separately. In addition, it may generate sufficient ions and accelerate them sufficiently, thereby increasing the ionic wind speed and energy efficiency. At the same time, spatial distribution and density distribution of the generated positive and negative ions may be easily controlled by controlling the position and direction of the electron beam, thereby enhancing controllability of the ionic wind.

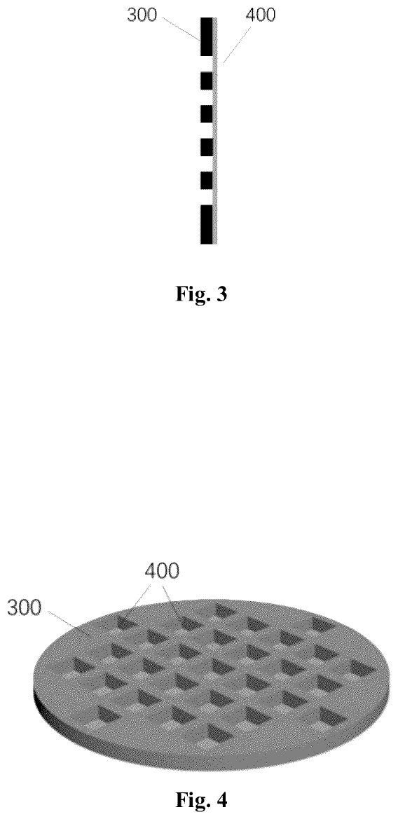

FIG. 2 shows a structure diagram of an electron beam ionization based ionic wind device according to some other embodiments of the disclosure. The electron beam ionization based ionic wind device 2000 shown in FIG. 2 differs from the electron beam ionization based ionic wind device 1000 shown in FIG. 1 in that the electron beam accelerating electrode 300 is positioned on the chamber wall of the vacuum chamber 100 and is fitted together with the electron beam exit window 400. FIGS. 3 and 4 show a fitting mode between the electron beam accelerating electrode 300 and the electron beam exit window 400. In the fitting mode shown in FIGS. 3 and 4, the electron beam accelerating electrode 300 is a grid electrode, which is fitted together with the electron beam exit window 400, and thus forming an array of multiple small exit windows. An advantage of the electron beam ionization based ionic wind device 2000 shown in FIG. 2 compared to the electron beam ionization based ionic wind device 1000 shown in FIG. 1 is that the grid structure of the electron beam accelerating electrode 300 can support the electron beam exit window 400. When the electron beam exit window 400 adopts a thin-film structure, thickness of the thin film may be greatly reduced, making it easier for the electron beam to be emitted to the outside of the vacuum chamber 100 through the electron beam exit window 400, and thus generating more ions and larger ionic wind.

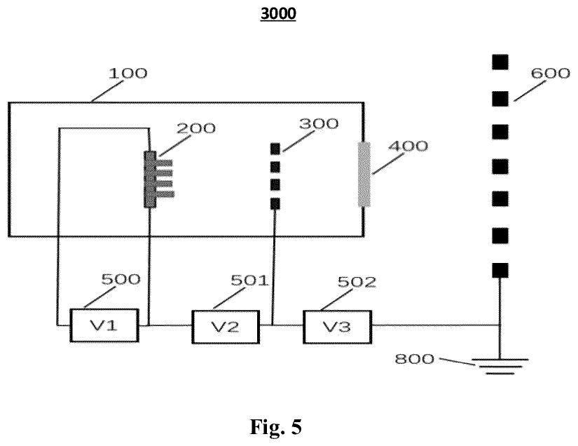

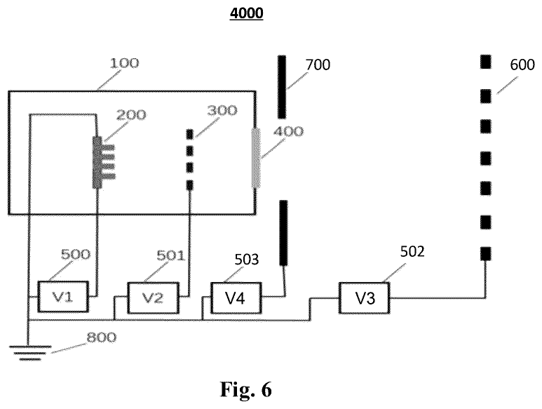

FIG. 5 shows a structure diagram of an electron beam ionization based ionic wind device according to some other embodiments of the disclosure. The electron beam ionization based ionic wind device 3000 shown in FIG. 5 differs from the electron beam ionization based ionic wind device 1000 shown in FIG. 1 in that the ion accelerating electrode 600 is grounded, and a high-voltage output terminal of the ion accelerating electrode power supply 502 is connected to the electron beam accelerating electrode 300. This connection mode makes the electron beam accelerating electrode 300 and the electron source 200 to be suspended as a whole at a positive or negative high voltage potential. At this time, the ion accelerating electric field may still be generated between the electron beam accelerating electrode 300 or the electron beam exit window 400 and the ion accelerating electrode 600.

FIG. 6 shows a structure diagram of an electron beam ionization based ionic wind device according to some other embodiments of the disclosure. The electron beam ionization based ionic wind device 4000 shown in FIG. 6 differs from the electron beam ionization based ionic wind device 1000 shown in FIG. 1 in that in addition to the vacuum chamber 100, the electron source 200, the electron beam accelerating electrode 300, the electron beam exit window 400, the electron source power supply 500, the electron beam accelerating electrode power supply 501, the ion accelerating electrode power supply 502, the ion accelerating electrode 600, and the grounding point 800, the electron beam ionization based ionic wind device 4000 also includes an ion accelerating electrode 700 and an ion accelerating electrode power supply 503, wherein the ion accelerating electrode power supply 503 supplies power for the ion accelerating electrode 700, so that the ion accelerating electric field is generated between the ion accelerating electrode 700 and the ion accelerating electrode 600. In this case, both the ion accelerating electrode 600 and the ion accelerating electrode 700 are positioned on one side, from which the electron beam is emitted to the outside of the vacuum chamber 1000 through the electron beam exit window 400, of vacuum chamber 100. The ion accelerating electrode 700 may be a flat panel electrode with a through-hole, and the ion accelerating electrode 600 may be a grid electrode. The advantage of the electron beam ionization based ionic wind device 4000 shown in FIG. 6 compared to the electron beam ionization based ionic wind device 1000 shown in FIG. 1 is that the ion accelerating electrode 600 and the ion accelerating electrode 700 can achieve a cascade acceleration effect, and thus achieve higher ionic wind speed. It should be understood that the number of cascaded ion accelerating electrodes may be further increased (such as third, fourth, etc.) to achieve greater ionic wind speed through multi-stage acceleration.

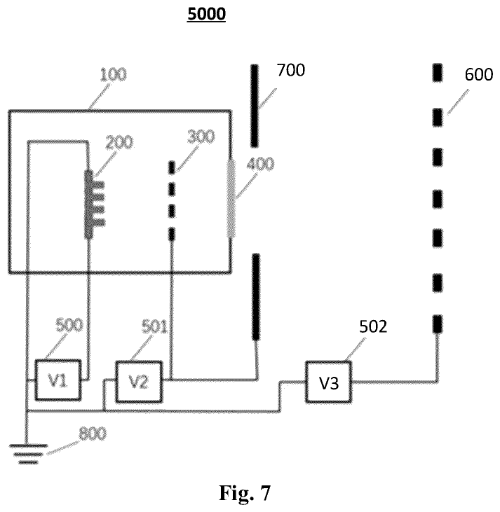

FIG. 7 shows a structure diagram of an electron beam ionization based ionic wind device according to some other embodiments of the disclosure. The electron beam ionization based ionic wind device 5000 shown in FIG. 7 differs from the electron beam ionization based ionic wind device 4000 shown in FIG. 6 in that the ion accelerating electrode power supply 503 is omitted, and the ion accelerating electrode 700 is connected to the electron beam accelerating electrode power supply 501, which simultaneously supplies power for both the electron beam accelerating electrode 300 and the ion accelerating electrode 700.

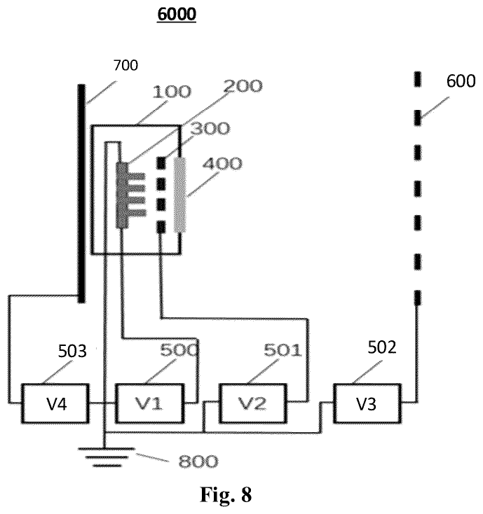

FIG. 8 shows a structure diagram of an electron beam ionization based ionic wind device according to some other embodiments of the disclosure. The electron beam ionization based ionic wind device 6000 shown in FIG. 8 differs from the electron beam ionization based electron wind device 4000 shown in FIG. 6 in that the vacuum chamber 100 is positioned between the ion accelerating electrode 600 and the ion accelerating electrode 700 (i.e., the ion accelerating electrode 600 and the ion accelerating electrode 700 are respectively positioned on opposite sides of the vacuum chamber 100).

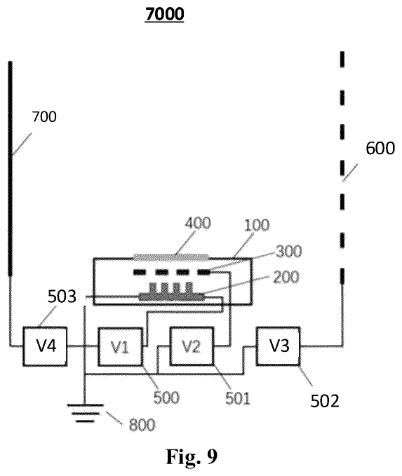

FIG. 9 shows a structure diagram of an electron beam ionization based ionic wind device according to some other embodiments of the disclosure. The electron beam ionization based ionic wind device 7000 shown in FIG. 9 differs from the electron beam ionization based electron wind device 6000 shown in FIG. 8 in that the vacuum chamber 100 is positioned on one side (the lower side shown in FIG. 9) between the ion accelerating electrode 600 and the ion accelerating electrode 700, and the direction of the electron beam incident on the atmospheric air is perpendicular to the direction of the ion accelerating electric field.

In some embodiments, any one of the electron source power supply 500, the electron beam accelerating electrode power supply 501, the ion accelerating electrode power supply 502, and the ion accelerating electrode power supply 503 may include one or more of a Direct Current (DC) power supply, an Alternate Current (AC) power supply, and a pulse power supply.

In some embodiments, each of the electron beam accelerating electrode 300, the ion accelerating electrode 600, and the ion accelerating electrode 700 may be made of a metal conductive material (e.g., one or more of gold, silver, copper, iron, stainless steel, tungsten, iridium, platinum, nickel, chromium, molybdenum, tantalum) or a semiconductor material (e.g., one or more of silicon, graphene, carbon nanotubes, titanium nitride, tantalum nitride, carbon, tungsten carbide).

In some embodiments, each of the electron beam accelerating electrode 300, the ion accelerating electrode 600, and the ion accelerating electrode 700 may adopt one or more of a spherical shape, a cylindrical shape, a semi-cylindrical shape, a flat panel shape, a curved flat panel shape, a grid shape, and a needle-tip shape.

It should be noted that although the electron source power supply 500, the electron beam accelerating electrode power supply 501, and the ion accelerating electrode power supply 502 and/or 503 are positioned outside the vacuum chamber 100 in the embodiments shown in FIGS. 1-2 and FIGS. 5-9, at least one of them may also be positioned inside the vacuum chamber 100. The electron beam ionization based ionic wind device according to embodiments of the disclosure may further include wires connecting the electron source 200 and the electron source power supply 500, the electron beam accelerating electrode 300 and the electron beam accelerating electrode power supply 501, and the ion accelerating electrode 600 and the ion accelerating electrode power supply 502 (and/or the ion accelerating electrode 700 and the ion accelerating electrode power supply 503), flanges or electrodes required for these wires to pass through the vacuum chamber 100, and support members supporting all of the above components.

Although certain embodiments have been illustrated and described herein for purposes of description, a wide variety of alternate and/or equivalent embodiments or implementations calculated to achieve the same purposes may be substituted for the embodiments shown and described without departing from the scope of the disclosure. This application is intended to cover any adaptations or variations of the embodiments discussed herein. Therefore, the embodiments described herein are limited only by the appended claims and the equivalents thereof.

What is claimed is:

1. An electron beam ionization based ionic wind device, comprising a vacuum chamber, an electron source, an electron beam accelerating electrode, an electron beam exit window, and an ion accelerating electrode, wherein:
the electron source is positioned inside the vacuum chamber and is used to generate an electron beam;
the electron beam accelerating electrode is positioned inside the vacuum chamber, or on a chamber wall of the vacuum chamber, or outside the vacuum chamber, and is used to accelerate the electron beam;
the electron beam exit window is positioned on the chamber wall of the vacuum chamber, through which the electron beam is emitted to the outside of the vacuum chamber and ionizes gas molecules or is attached to gas molecules outside the vacuum chamber to form ions; and
the ion accelerating electrode is positioned outside the vacuum chamber and is used to accelerate the ions to generate ionic wind.

2. The electron beam ionization based ionic wind device of claim 1, wherein the electron source comprises one or more of a thermionic emission electron source, a field emission electron source, and a tunneling electron source.

3. The electron beam ionization based ionic wind device of claim 1, wherein the electron source comprises a focusing device.

4. The electron beam ionization based ionic wind device of claim 1, wherein the electron beam exit window has a thin-film or micropore structure.

5. The electron beam ionization based ionic wind device of claim 1, wherein the electron beam exit window, the electron source and the electron beam accelerating electrode are aligned in a straight line.

6. The electron beam ionization based ionic wind device of claim 1, wherein the electron beam accelerating electrode is positioned on the chamber wall of the vacuum chamber and is fitted together with the electron beam exit window.

7. The electron beam ionization based ionic wind device of claim 1, wherein the ion accelerating electrode comprises multiple ion accelerating electrodes.

8. The electron beam ionization based ionic wind device of claim 7, wherein the multiple ion accelerating electrodes are positioned on one side, from which the electron beam is emitted to the outside of the vacuum chamber, of the vacuum chamber.

9. The electron beam ionization based ionic wind device of claim 7, wherein a first ion accelerating electrode and a second ion accelerating electrode of the multiple ion accelerating electrodes are positioned on opposite sides of the vacuum chamber, respectively.

10. The electron beam ionization based ionic wind device of claim 1, further comprising at least one of an electron source power supply, an electron beam accelerating electrode power supply, and an ion accelerating electrode power supply, wherein the electron source power supply is used to supply power for the electron source, the electron beam accelerating electrode power supply is used to supply power for the electron beam accelerating electrode, and the ion accelerating electrode power supply is used to supply power for the ion accelerating electrode, and at least one of the electron source power supply, the electron beam accelerating electrode power supply, and the ion accelerating electrode power supply comprises one or more of a Direct Current (DC) power supply, an Alternate Current (AC) power supply, and a pulse power supply.

11. The electron beam ionization based ionic wind device of claim 1, wherein each of the electron beam accelerating electrode and the ion accelerating electrode is made of a metal conductive material or a semiconductor material.

12. The electron beam ionization based ionic wind device of claim 1, wherein each of the electron beam accelerating electrode and the ion accelerating electrode adopts one or more of a spherical shape, a cylindrical shape, a semi-cylindrical shape, a flat panel shape, a curved flat panel shape, a grid shape, or a needle-tip shape.
